(19) United States
(12) Patent Application Publication
(10) Pub. No.: US 2006/0241895 A1
(43) Pub. Date: Oct. 26, 2006

(54) Sensing wheel

(76) Inventors: Rainer Falsett, Babenhausen (DE); Roland Fischer, Nidderau (DE); Reinhard Seyer, Rodgau (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/530,395

(22) PCT Filed: Sep. 20, 2003
(86) PCT No.: PCT/EP03/10512

§ 371 Date: Feb. 6, 2006

(30) Foreign Application Priority Data
Oct. 8, 2002 (DE) 102-46-806.0

(51) Int. Cl. G06F 15/00

(52) U.S. Cl. 702/151

(57) ABSTRACT

A sensing wheel for a device for measuring the rotational speed and/or rotational angle of a crankshaft of an internal combustion engine has a plurality of peripherally arranged teeth, which each have a front edge and a rear edge, which define the width of the respective tooth, and tooth gaps situated between the teeth. The front edges or rear edges of each of the teeth are spaced at basically the same angular interval from one another. A limited number of different tooth widths are provided over the entire periphery, the sequence of the tooth widths of at least three successive teeth over the entire periphery being unambiguous.

The invention relates to a sensing wheel for a device for measuring the rotational angle of a crankshaft of the type more specifically defined in the preamble of claim 1. The invention further relates to a device for measuring the rotational angle of a crankshaft according to claim 5.

A sensing wheel and a corresponding device are disclosed by DE 195 21 277 A1 or EP 0 684 375 A1.

These sensing wheels are provided at their periphery with a plurality of teeth, which at the rotation of the sensing wheel, rigidly connected to the crankshaft, relay information on the rotational speed and the angular position of the crankshaft to a fixed pulse sensor. From the values supplied by the pulse sensor in the form of electrical signals, a control unit can determine the position of all pistons of the internal combustion engine, since the pistons are rigidly connected to the crankshaft by connecting rods. This rigid connection means that only one pulse sensor is required for the whole internal combustion engine.

The teeth, uniformly distributed over the periphery of the sensing wheel, supply the information relating to the angular velocity and/or the rotational speed of the crankshaft in the form of the time interval between the occurrence of successive signals generated by the front edge of each of the individual teeth. In order to be able to detect the angular position of the crankshaft, two or more teeth are omitted, so that the pulse sensor detects this gap during the rotation of the sensing wheel and relays this to the control unit. From the zero position and the measured angular velocity as described above, the control unit is consequently in a position to determine the angular position of the crankshaft at any time. This is necessary in order to keep to the correct instant for the injection of fuel into the combustion chambers and the correct ignition point.

In phases with marked fluctuations in the rotational speed, however, determination of the crankshaft angle is very imprecise since interpolation, which works with the values of the previous pulse measurement, is always necessary for this purpose. Added to this is the fact that the calculation demands placed on the control unit are very great, particularly at high rotational speeds, since at each pulse supplied by the sensing wheel an interrupt is triggered in the processor, obliging it to interrupt its calculations.

A further disadvantage of these sensing wheels and of the devices in which they are used is that in the worst case, when starting the internal combustion engine, an entire revolution of the crankshaft is necessary in order to determine the angular position, since only then can the gap produced by the omission of the teeth be safely assumed to have passed the pulse sensor. This leads to an unduly long period of time in which the internal combustion engine and the control unit are not synchronized.

In modern internal combustion engines, however, in which so called start-stop operating modes are being introduced in pursuit of fuel consumption benefits and ever lower emission limits, such synchronization is essential so as not to impose any penalties on the driver in terms of comfort.

Arrangements with variable tooth length are also disclosed, for example, by U.S. Pat. No. 4,972,332 A1 or DE 3431232 A1.

An object of the invention therefore is to create a sensing wheel for a device for measuring the rotational angle of a crankshaft, which is capable within the shortest possible time of supplying information with regard to the angular position of the crankshaft to a pulse sensor, in order to create the fastest possible synchronization between a control unit and the internal combustion engine.

According to the invention this object is achieved by the features specified in claim 1.

The variable width of successive teeth provided according to the invention allows the angular position of the crankshaft to be calculated solely from a sequence of tooth widths, if corresponding, successive combinations of tooth widths of at least three successive teeth, distributed over the periphery of the sensing wheel, each occur only once and are assigned to a specific angular position. In this way the evaluation of the tooth widths leads to a finding with regard to the angular position of the crankshaft even from a very small rotational angle.

This advantageously makes it possible to dispense with costly methods for bridging missing teeth, as are required in the case of known sensing wheels and the associated devices. A further advantage of the sensing wheel according to the invention is that known or existing pulse sensors can continue to be used.

If, in an advantageous development of the invention, four different tooth widths are provided over the entire periphery, the angular position of the crankshaft at any given time can be precisely determined by determining the width of three successive teeth.

A device for measuring the rotational angle of a crankshaft of an internal combustion engine is set forth in the independent claim 5.

Further advantageous developments and further embodiments of the invention are revealed in the remaining dependent claims and in the exemplary embodiment outlined below with reference to the drawing, in which:

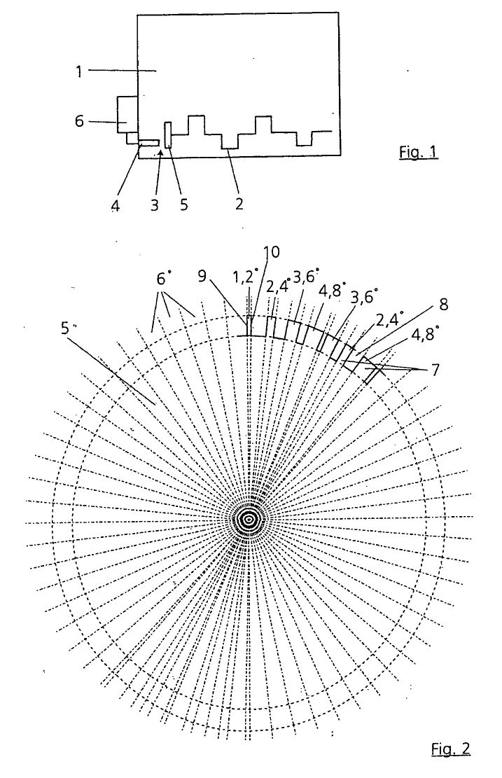

FIG. 1 shows a schematic representation of a device according to the invention for measuring the rotational angle of a crankshaft; and

FIG. 2 shows a sensing wheel according to the invention.

An internal combustion engine 1 represented extremely schematically in FIG. 1 has a crankshaft 2, to which connecting rods and pistons (not shown) are fitted in a manner known in the art. The pistons, in a likewise known manner, perform an oscillatory movement in corresponding cylinders of the internal combustion engine 1, on the basis of the rotation of the crankshaft 2.

The internal combustion engine 1 is furthermore provided with a device 3 for measuring the rotational angle and possibly the rotational speed of the crankshaft 2, the device having a pulse sensor 4 fixedly attached to the internal combustion engine 1 and a sensing wheel 5 fixed to the crankshaft 2 and consequently rotating therewith. As will be clear from the following, the pulse sensor 4, which may be of a type known in the art, receives signals from the sensing wheel 5 and relays these to a control unit 6, in order to calculate from these the speed and/or the rotational angle of the crankshaft 2. These calculations are necessary in order to keep to the correct injection and ignition timings of the internal combustion engine.

The sensing wheel 5 represented in more detail in FIG. 2 is provided at its periphery with a plurality of teeth 7, between which respective tooth gaps 8 are situated. In this instance there are a total of sixty teeth 7, which are distributed uniformly over the periphery of the sensing wheel 5 and the front edges 9 of which are spaced at an interval of 6° from one another. A different number of teeth 7 could naturally also be provided, the number of sixty teeth 7 having proved highly suitable. In particular, this permits the use of an identical pulse sensor 4 to those in known devices. If the teeth 7, as in this instance, are arranged at uniform angular intervals from one another, the angular velocity of the sensing wheel 5 and hence the rotational speed of the crankshaft 2 can readily be determined in a manner known in the art from a front edge 9 of the respective tooth 7 passing the pulse sensor 4.

In order to be able to determine the instantaneous angular position of the crankshaft 2 at any time, the teeth 7 have different widths, which is explained in more detail below with reference to an example. It should be noted in this context that the term “width of each tooth 7” is taken to mean the angular distance of the front edge 9 from the rear edge 10 of the respective tooth 7.

FIG. 2 shows the different design of the teeth 7 over just one particular part of the periphery of the sensing wheel 5. It can be seen, however, that the width of the teeth 7 varies in four increments, in this case in the increments 1.2°, 2.4°, 3.6° and 4.8°. These four different increments, however, only enable the pulse sensor 4 to identify four different conditions. This is obviously insufficient for a precise determination of the angular position of the crankshaft 2. Even the evaluation of two successive teeth only gives a possible variation of 4²=16 conditions. This value is likewise still too imprecise for controlling the internal combustion engine 1.

For this reason the control unit 6 in each case uses the sequence of three successive teeth 7, allowing a total of 4³=64 conditions to be detected and the angular position of the crankshaft 2 to be determined after a rotation of 18°.

The respective tooth sequences are evaluated by means of appropriate software in the control unit 6 and used for determining the precise angle of the crankshaft 2. To do this each combination of different tooth widths occurring over the periphery of the sensing wheel 5 is unambiguously assigned to a specific angular position of the crankshaft 2 and filed in the software of the control unit 6.

On the basis of the 6° angular interval between each of the teeth 7 described above, giving 60 teeth 7 over the periphery of the sensing wheel 5, the number of these 64 different combinations is sufficient. Since this even leaves four combinations spare, these can be used for monitoring the measured result, that is for an integrity check. In this instance, at no point on the sensing wheel 5 do the same widths occur three times in succession, so that these four combinations remain spare.

Instead of the four different increments it would theoretically also be possible to provide a larger number of increments. If, for example, eight different increments or tooth widths were distributed over the periphery of the sensing wheel 5, the angular position of the crankshaft 2 could be determined from just two teeth 7. This would result, however, in many slight differences between the individual widths of the teeth 7, so that the detection of tooth widths by the pulse sensor 4 would be much more difficult and could well lead to incorrect results at high rotational speeds. In this context five different increments could be provided, so that measuring three successive tooth widths would produce a total of 125 different possibilities. This could then lead to a smaller angular interval between the individual teeth 7, for example to an interval of 3°, so that in theory a more precise speed measurement would be possible.

In this instance the front edges 9 of the teeth 7 are spaced at the same interval from one another and the width of the teeth 7 is formed solely by a variation of the rear edges 10. However, an embodiment of the sensing wheel 5, in which the rear edges 10 are spaced at the same interval from one another and the variation in the width of the teeth 7 is brought about by the offset of the front edges 9, would naturally also be feasible. However, this would mean that the angular velocity of the sensing wheel 5 and hence the rotational speed and/or the rotational angle of the crankshaft 2 would have to be measured on the rear edges 10 of the teeth 7.

1. A sensing wheel for a device for measuring the rotational angle of a crankshaft of an internal combustion engine comprising:
a plurality of peripherally arranged teeth, each having a front edge and a rear edge, which define a width of the respective tooth, and
tooth gaps situated between the teeth, respective front edges or rear edges of the teeth being spaced at basically the same angular interval from one another, said teeth having a limited number of different tooth widths provided over an entire periphery of the sensing wheel,
wherein a sequence of the tooth widths of at least three successive teeth within a rotational angle of up to 18° over the entire periphery is unambiguous.

2. The sensing wheel as claimed in claim 1, wherein the limited number of different tooth widths is four different tooth widths provided over the entire periphery of the sensing wheel.

3. The sensing wheel as claimed in claim 1 wherein a width of each tooth and a width of a succeeding or preceding tooth gap extend over approximately 6°.

4. The sensing wheel as claimed in claim 2 wherein a width of each tooth and a width of a succeeding or preceding tooth gap extend over approximately 6°.
